(19) United States
(12) Patent Application Publication
(10) Pub. No.: US 2015/0177849 A1
(43) Pub. Date: Jun. 25, 2015

(54) TOUCH-CONTROL TYPE KEYBOARD

(71) Applicant: TIANJIN FUNAYUANCHUANG TECHNOLOGY CO., LTD., Tianjin (CN)

(72) Inventors: PO-SHENG SHIH, New Taipei (TW); CHIH-CHIEH CHANG, New Taipei (TW); CHIEN-YUNG CHENG, New Taipei (TW)

(21) Appl. No.: 14/571,925

(22) Filed: Dec. 16, 2014

(30) Foreign Application Priority Data
Dec. 20, 2013 (CN) 201310706963.9

(51) Int. Cl. G06F 3/023; G06F 3/044

(52) U.S. Cl. CPC G06F 3/0233; G06F 3/044

(57) ABSTRACT

The present disclosure relates to a touch-control type keyboard. The touch-control type keyboard includes a cover board and a touch module. The cover board includes a first surface and a second surface. The cover board defines a number of keys on the first surface, and at least one of the keys is a function key. The touch-control module is located on the second surface of the cover board. The touch-control module comprises at least two conductive films and an integrated circuit. The at least two conductive films are coplanar and spaced from each other. The at least one function key is independently located at a position corresponding to one of the at least two conductive films. Each of the at least two conductive films is independently electrically connected to the integrated circuit.

### CROSS-REFERENCE TO RELATED APPLICATIONS

This application claims all benefits accruing under 35 U.S.C. §119 from China Patent Application No. 201310706963.9, filed on Dec. 20, 2013, in the China Intellectual Property Office, the contents of which are hereby incorporated by reference.

### BACKGROUND

1. Technical Field

The disclosure generally relates to keyboards, and particularly to a touch-control type keyboard.

2. Description of Related Art

Conventional keyboards on the market are mostly mechanical typewriter-style keyboards, such as stand-alone keyboards and matrix keyboards. With the demand for thin and flexible keyboards, touch-control type keyboards have been widely used.

Conventional keyboards mostly have two or more layers of conductive films. A single-layer conductive film can reduce the thickness and the cost of the touch-control type keyboards, and can also accurately achieve a two point touch. However, the touch-control type keyboards need to perform a function of a three point touch, such as “Ctrl+alt+delete” operation. Although multi-point touch detection methods of the single-layer conductive film have been reported, the detection methods are very complex, and difficult to achieve in practical application.

### BRIEF DESCRIPTION OF THE DRAWING

Implementations of the present technology will now be described, by way of example only, with reference to the attached figures.

FIG. 1 is a top structure view of a first embodiment of a touch-control type keyboard.

FIG. 2 is an exploded view of the touch-control type keyboard of FIG. 1.

FIG. 3 shows a Scanning Electron Microscope image of a drawn carbon nanotube film.

FIG. 4 shows a triangular pattern of an indium tin oxide film.

FIG. 5 is a connection diagram of a driving circuit and a sensing circuit of a touch module.

FIG. 6 is a simplified circuit diagram of the touch-control type keyboard of FIG. 1.

FIG. 7 is a cross-sectional view of the first embodiment of another touch-control type keyboard.

FIG. 8 is an exploded view of the touch-control type keyboard of FIG. 7.

FIG. 9 is an exploded view of a second embodiment of a touch-control type keyboard.

FIG. 10 is a top schematic view of a third embodiment of a touch-control type keyboard.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

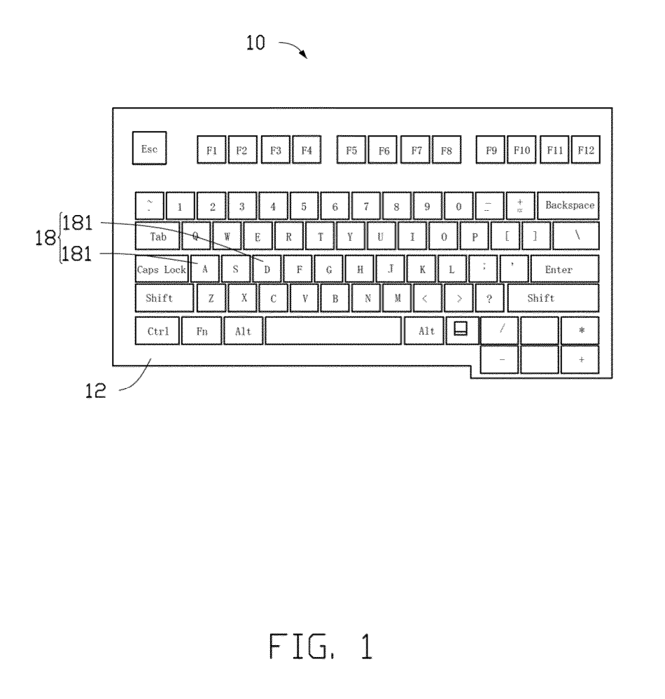

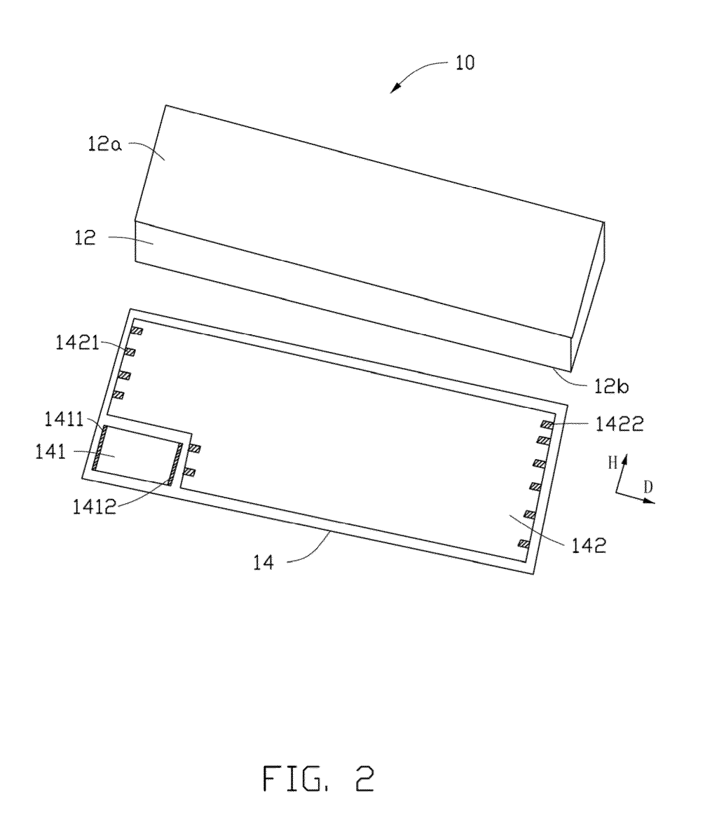

FIG. 1 and FIG. 2 illustrate that a first embodiment of a touch-control type keyboard 10 includes a cover board 12 and a touch-control module 14. The cover board 12 and the touch-control module 14 are laminated together. The cover board 12 covers the touch-control module 14, and is in contact and fixed on the touch-control module 14. The cover board 12 has a first surface 12a and a second surface 12b opposite to the first surface 12a. The first surface 12a is the surface nearest to the user and configured to be used as an operating surface of the touch-control type keyboard 10.

A material of the cover board 12 can be a rigid material or a flexible material. The flexible material can be plastic or resin, such as polyethylene terephthalate (PET), poly methyl methacrylate (PMMA), polycarbonate (PC), Polyether sulfone (PES), cellulose acetate, polyvinyl chloride (PVC), benzocyclobutene (BCB), and acrylic resin. The rigid material can be glass or crystal. The cover board 12 can be partially transparent or transparent. The cover board 12 is used to support and protect the touch-control module 14 to improve durability of the touch-control type keyboard 10. The cover board 12 can also be used to provide some additional features, such as reduce glare or reflection. In one embodiment, the cover board 12 is a rectangular glass substrate.

A plurality of keys (not shown) is located on the first surface 12a of the cover board 12. At least one of the plurality of keys is a function key. The keys are arranged in a plurality of rows, and each row includes at least one key. The keys in the same row can have the same width, and the length of the keys in the same row can be different from each other. The width of the keys is a size along a direction perpendicular to the row. The length of the keys is a size along a direction parallel to the row. The cover board 12 can be divided into a plurality of protrusions according to the position of the plurality of keys, and each protrusion corresponds to one key.

The touch-control module 14 can be a super-thin multi-points capacitance type touch-control module. The touch-control module 14 includes a first conductive film 141, a second conductive film 142 and an integrated circuit (not shown). The first conductive film 141 is located at a position that corresponds to the “Ctrl” key. In one embodiment, the “Ctrl” key is located at bottom left corner of the touch-control type keyboard 10. The second conductive film 142 is located at a position that corresponds to the other keys except the “Ctrl” key. Each of the first conductive film 141 and the second conductive film 142 consists of a single-layer conductive film. The first conductive film 141 and the second conductive film 142 are coplanar such as being located on the same surface of a substrate. The first conductive film 141 and the second conductive film 142 are independent and spaced from each other. The first conductive film 141 and the second conductive film 142 are respectively connected to the integrated circuit by separate wires.

Each of the first conductive film 141 and the second conductive film 142 can be a single-layer anisotropic impedance conductive film. Direction D is defined as a lowest impedance direction. Conductivity along direction D is much larger than conductivity along other directions. Direction H is defined as a highest impedance direction. Conductivity along direction H is much smaller than conductivity along other directions. Direction D is substantially perpendicular to direction H. The single-layer anisotropic impedance conductive film can be a carbon nanotube film. In one embodiment, the first conductive film 141 is not an anisotropic impedance conductive film.

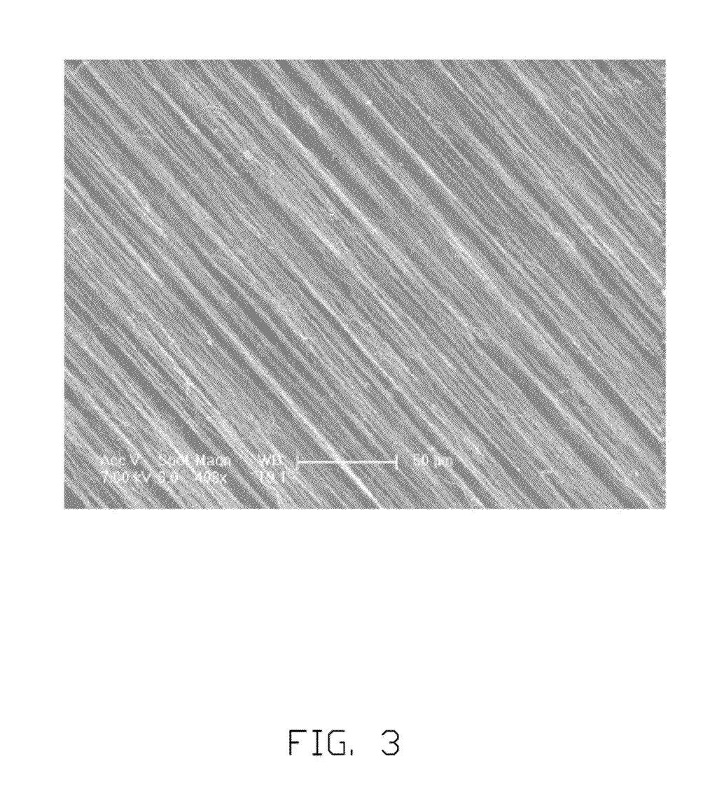

FIG. 3 illustrates that in one embodiment, each of the first conductive film 141 and the second conductive film 142 is a single-layer carbon nanotube film. The carbon nanotube film can be formed by drawing from a carbon nanotube array. In the carbon nanotube film drawn from the carbon nanotube array, the overall aligned direction of a majority of carbon nanotubes is substantially aligned along the same direction parallel to a surface of the carbon nanotube film. A majority of the carbon nanotubes are substantially aligned along the same direction in the carbon nanotube film. Along the aligned direction of the carbon nanotubes, each carbon nanotube is joined to adjacent carbon nanotubes end to end by van der Waals force, whereby the carbon nanotube film is capable of being a free-standing structure. The carbon nanotube film drawn from the carbon nanotube array is transparent. In one embodiment, the carbon nanotube film is substantially a pure film and consists essentially of just the carbon nanotubes, to increase the transparency of the touch-control module. There may be a minority of carbon nanotubes in the carbon nanotube film that are randomly aligned. However, the number of the randomly aligned carbon nanotubes is very small and does not affect the overall oriented alignment of the majority of carbon nanotubes in the carbon nanotube film. The majority of the carbon nanotubes in the carbon nanotube film that are substantially aligned along the same direction may not be exactly straight, and can be curved at a certain degree, or are not exactly aligned along the overall aligned direction, and can deviate from the overall aligned direction by a certain degree. Therefore, partial contacts can exist between the juxtaposed carbon nanotubes in the majority of the carbon nanotubes aligned along the same direction in the carbon nanotube film. The carbon nanotube film can be a substantially pure structure of carbon nanotubes with few impurities. A thickness of the carbon nanotube film at the thickest location is about 0.5 nanometers to about 100 microns (e.g., in a range from 0.5 nanometers to about 10 microns).

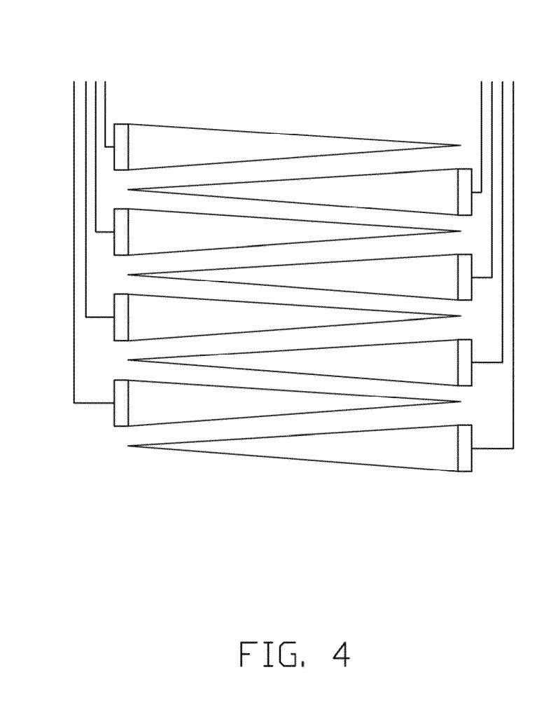

The first conductive film 141 and the second conductive film 142 are not limited to the carbon nanotube film. The first conductive film 141 and the second conductive film 142 can be other conductive films, such as a patterned indium tin oxide (ITO) film. FIG. 4 illustrates that in one embodiment, the second conductive film 142 can be an indium tin oxide film with a plurality of isosceles triangle patterns. The plurality of isosceles triangle patterns is arranged parallel to each other at equal intervals. Adjacent two of the plurality of isosceles triangle patterns is oppositely arranged. The patterned indium tin oxide film is not limited to the indium tin oxide film with a plurality of isosceles triangle patterns, and any patterned indium tin oxide film can be used as long as the patterned indium tin oxide film has a width gradient along one direction.

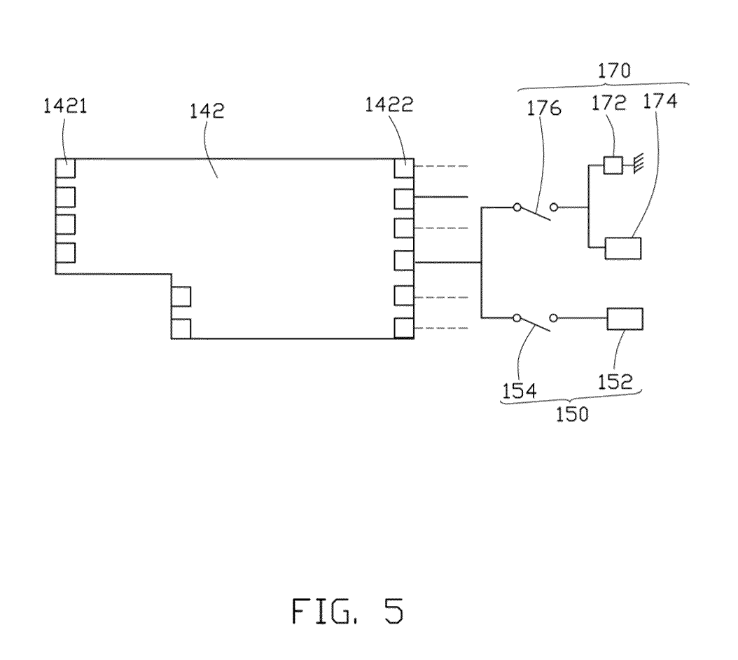

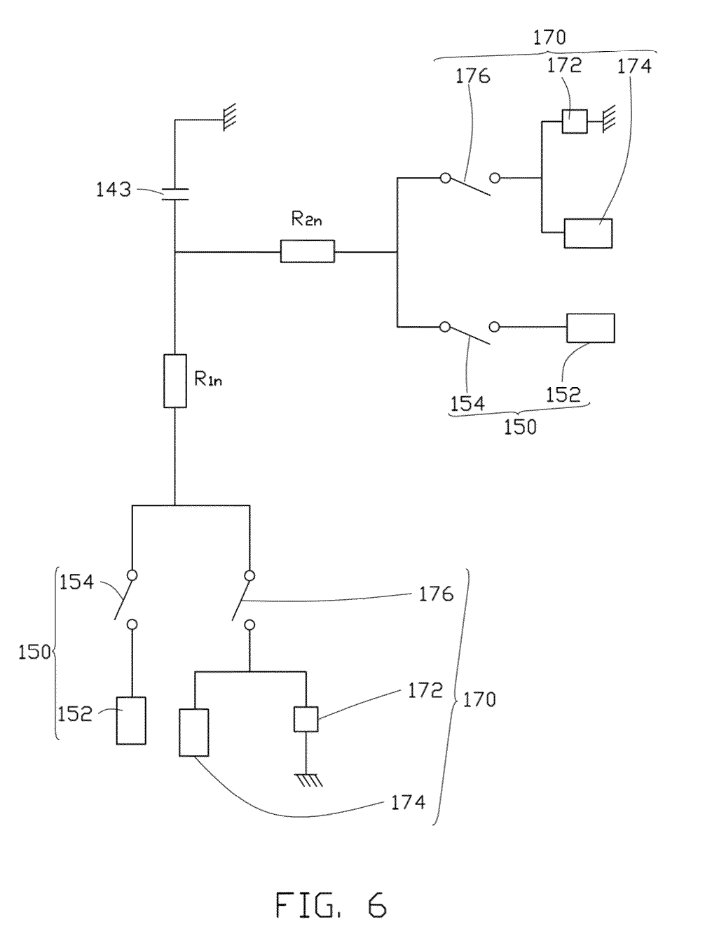

FIG. 5 and FIG. 6 illustrate that the integrated circuit includes a driving circuit 150 and a sensing circuit 170. A first electrode 1411 and a second electrode 1412 are located on the opposite sides of the first conductive film 141, and they are extended along direction H. The first electrode 1411 and the second electrode 1412 are electrically connected to the first conductive film 141. Each of the first electrode 1411 and the second electrode 1412 is connected to the driving circuit 150 and the sensing circuit 170. The shapes of the first electrode 1411 and the second electrode 1412 can be linear, such as wire-shaped or strip-shaped. The first electrode 1411 and the second electrode 1412 can also be located on the same side of the first conductive film 141.

A plurality of third electrodes 1421 and a plurality of fourth electrodes 1422 can be located on the opposite sides of the second conductive film 142, and they are arranged along direction H. The plurality of third electrodes 1421 and the plurality of fourth electrodes 1422 can also be located on the same side of the second conductive film 142, and they are arranged along direction H. The plurality of third electrodes 1421 and the plurality of fourth electrodes 1422 are electrically connected to the second conductive film 142. Each of the plurality of third electrodes 1421 and the plurality of fourth electrodes 1422 is connected to the driving circuit 150 and the sensing circuit 170. The plurality of third electrodes 1421 can correspond to the plurality of fourth electrodes 1422 in a one to one manner. The plurality of third electrodes 1421 and the plurality of fourth electrodes 1422 can also be dislocated in a one to one manner. Thus, a wiring between each of the plurality of third electrodes 1421 and one of the plurality of fourth electrodes 1422 is substantially parallel to, or intersects with, direction D of the second conductive film 142.

The driving circuit 150 includes a charging circuit 152 and a first switch 154. The first switch 154 is used to control the charging circuit 152. The charging circuit 152 is connected in series with each of the plurality of third electrodes 1421 or the plurality of fourth electrodes 1422 by the first switch 154. The charging circuit 152 can be connected to a voltage source (not shown). The sensing circuit 170 includes a memory circuit 172, a readout circuit 174, and a second switch 176. The second switch 176 is used to control the memory circuit 172 and the readout circuit 174. The memory circuit 172 is connected in parallel with the readout circuit 174. The memory circuit 172 is connected in series with each of the plurality of third electrodes 1421 or the plurality of fourth electrodes 1422 by the second switch 176. The driving circuit 150 and the sensing circuit 170 are connected in parallel to each other. The memory circuit 172 can be connected in series with a resistor (not shown), for example the memory circuit 172 is connected to ground through the resistor.

The first electrode 1411, the second electrode 1412 and the first conductive film 141 can constitute a first touch pad. The plurality of third electrodes 1421, the plurality of fourth electrodes 1422 and the second conductive film 142 can constitute a second touch pad. The first touch pad and the second touch pad are respectively electrically connected to the integrated circuit by separate wires.

In the first embodiment, the detection principle of a touch point is as follows: when an area of the touch-control module 14 corresponding to the second conductive film 142 is touched, the touch point and the second conductive film 142 constituting a coupling capacitor 143, and a value of the coupling capacitor 143 is C. A resistance of the second conductive film 142 between the touch point and each of the plurality of third electrodes 1421 is R₁ₙ (n=1, 2, 3, . . . y, x, z . . . , n represents the plurality of third electrodes 1421). A resistance of the second conductive film 142 between the touch point and each of the plurality of fourth electrodes 1422 is R₂ₙ (n=1, 2, 3, . . . y, x, z . . . , n represents the plurality of fourth electrodes 1422). A pulse signal is input to each of the plurality of third electrodes 1421 by the driving circuit 150. R₁ₙ of each of the plurality of third electrodes 1421 and C are read by the sensing circuit 170 to obtain a plurality of values of R₁ₙ·C. A first curve is obtained by curve fitting the plurality of values of R₁ₙ·C. The touch point coordinate along direction H of the second conductive film 142 can be determined by the first curve. A pulse signal is input to each of the plurality of fourth electrodes 1422 by the driving circuit 150. R₂ of each of the plurality of fourth electrodes 1422 and C are read by the sensing circuit 170 to obtain a plurality of values of R₂ₙ·C. A second curve is obtained by curve fitting the plurality of values of R₂ₙ·C. The touch point coordinate along direction D of the second conductive film 142 can be determined by the first curve and the second curve.

A method of determining the touch point coordinate along direction H of the second conductive film 142 by the first curve comprises the following steps: Firstly, detecting a smallest value R_{1z}C, a second smallest value R_{1y}C, and a third smallest value R_{1z}C of the first curve. The second smallest value R_{1y}C is adjacent to the smallest value R₁ₓC; and the third smallest value R_{1z}C is adjacent to the second smallest value R_{1y}C. Secondly, detecting direction H coordinate Xₓ, X_{y}, X_{z}, Xₓ, X_{y}, and X_{z} is corresponding to the smallest value, the second smallest value, and the third smallest value respectively. Finally, the touch point coordinate along direction H can be obtained by interpolation.

A method of determining the touch point coordinate along direction D of the second conductive film 142 by the first curve and the second curve comprises the following steps: Firstly, detecting a smallest value R₂ₓC and a second smallest value R_{2y}C of the second curve. The second smallest value R_{2y}C is adjacent to the smallest value R₂ₓC. Secondly, comparing a sum of R₂ₓC and R_{2y}C with a sum of R₁ₓC and R_{1y}C. Finally, the touch point coordinates along direction D can be obtained.

The first electrode 1411, the second electrode 1412, the third electrode 1421 and the fourth electrode 1422 are made of conductive material, such as metal, alloy, conductive adhesive, antimony tin oxide (ATO), conductive carbon nanotubes or indium tin oxide (ITO). In one embodiment, the first electrode 1411, the second electrode 1412, the third electrode 1421 and the fourth electrode 1422 are made by printing conductive silver slurry. A signal input to the carbon nanotube film from the first electrode 1411, the second electrode 1412, the third electrode 1421 and the fourth electrode 1422 is mainly transported along direction D. The touch-control module 14 can determine a touch point position by a directional signal transmission. The size and space of the first electrode 1411, the second electrode 1412, the third electrode 1421 and the fourth electrode 1422 are not limited and can be selected according to need.

An adhesive layer (not shown) can be located between the touch-control module 14 and the cover board 12. The adhesive layer can firmly bond the touch-control module 14 to the cover board 12. A material of the adhesive layer can be pressure sensitive adhesive, thermal sensitive adhesive, or photo sensitive adhesive. The thickness of the adhesive layer can range from about 4 μm to about 8 μm. However, the adhesive layer is not necessary. When the first conductive film 141 and the second conductive film 142 of the touch-control module 14 have a certain viscosity, the touch-control module 14 can be directly adhered to the second surface 12b of the cover board 12. In one embodiment, because the carbon nanotube film itself has a viscosity, the carbon nanotube film can be directly adhered to the second surface 12b of the cover board 12, which can simplify the structure of the touch-control module 14 and reduce costs.

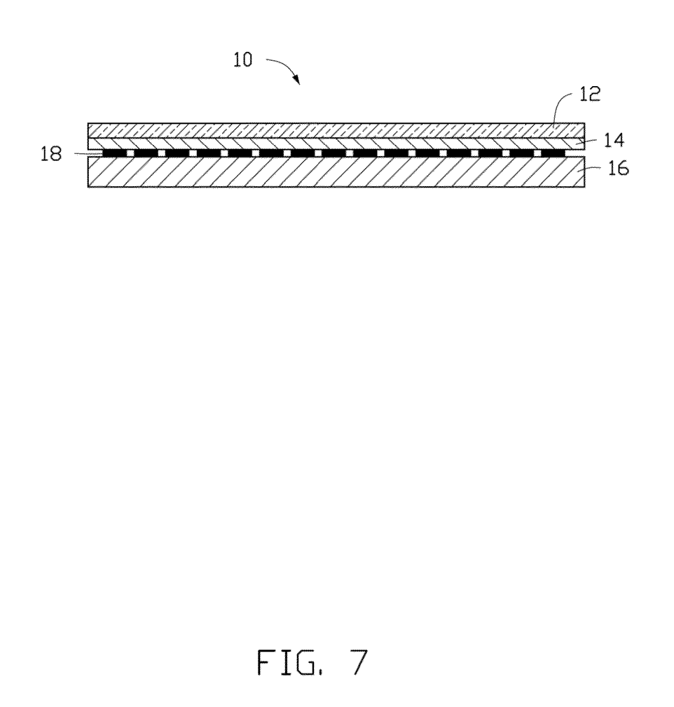

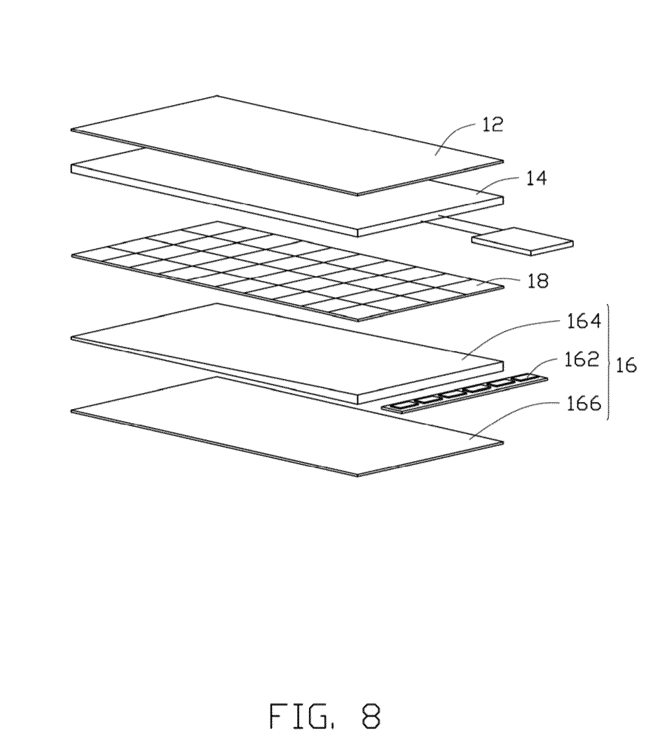

FIG. 7 and FIG. 8 illustrate that the touch-control type keyboard 10 further includes a backlight module 16. The backlight module 16, the cover board 12, and the touch-control module 14 are laminated together. The backlight module 16 is located on a side of the touch-control module 14 that is spaced from the cover board 12.

The backlight module 16 can include a light source 162 and a light guide plate 164. The light guide plate 164 includes an upper surface, a bottom surface opposite to the upper surface, and a side surface connecting the upper surface and the bottom surface. The side surface is used as a light input surface, and the upper surface is used as a light output surface. The light source 162 is located at a position opposite to the light input surface. The bottom surface of the light guide plate 164 can have a reflecting film 166 to reflect the light uniformly to the light output surface. The bottom surface can have a plurality of microstructures to uniformly reflect the lights. The material of the light guide plate 164 can be PC, PMMA, or acrylic resin. The reflecting film 166 can be a metal film, such as an aluminum film or a silver film. The light source 162 can be a spot light source or a linear light source, such as a light emitting diode and fluorescent lamp tube. Furthermore, the light output surface can include a plurality of microstructures (not shown). The microstructure can be hemispherical, cylindrical, frustum, prism, or symbol shaped, convex, or concave. In one embodiment, the microstructures of the light guide plate 164 can also visually emphasize the positions of the keys. The microstructures can be formed on the light guide plate 164 by using an injection molding method. In one embodiment, the microstructures are concave and hemispherical.

The touch-control type keyboard 10 can also include a keyboard marking layer 18. The keyboard marking layer 18 can be located between the cover board 12 and the touch-control module 14, or can be located between backlight module 16 and the touch-control module 14, or can be located on the first surface 12a of the cover board 12. The keyboard marking layer 18 includes a plurality of key symbols 181 used for marking the keys. The key symbols 181 can be transparent or partially transparent. The key symbols 181 can be English characters such as the letters “A” to “Z”, Arabic numerals, and other symbols. The backlight module 16 is located below the touch-control module 14 to help the user clearly see the key symbols in the keyboard marking layer 18.

The keyboard marking layer 18 can be formed on a surface of the cover board 12, the touch-control module 14, or the backlight module 26 by a marking method such as screen printing, laser printing, etching, plating, and spraying.

In the first embodiment, the keyboard marking layer 18 is located between the touch-control module 14 and the backlight module 16. Each of the key symbols 181 has a rectangular frame and a symbol such as the English letters “A” to “Z”, numbers “0” to “9”, and other symbols.

The keyboard marking layer 18 is an optional structure. In some embodiments, the touch-control type keyboard 10 does not utilize a keyboard marking layer 18 to enable the user to visually distinguish the positions of the keys. For example, the first surface 12a of the cover board 12 can be formed microstructures and can have the shape of the keys names.

In the first embodiment, when the touch objects simultaneously touch a first area of the touch-control module 14 corresponding to the first conductive film 141 and a second area of the touch-control module 14 corresponding to the second conductive film 142, the touch-control type keyboard 10 can achieve three point touch, such as “Ctrl+Shift+K” or other keys to perform a command input. Each of the first conductive film 141 and the second conductive film 142 consists of a single-layer carbon nanotube film. Since the carbon nanotube film has impedance anisotropy, the carbon nanotube film can achieve approximate patterned effect without additional patterning process, which can reduce the costs.

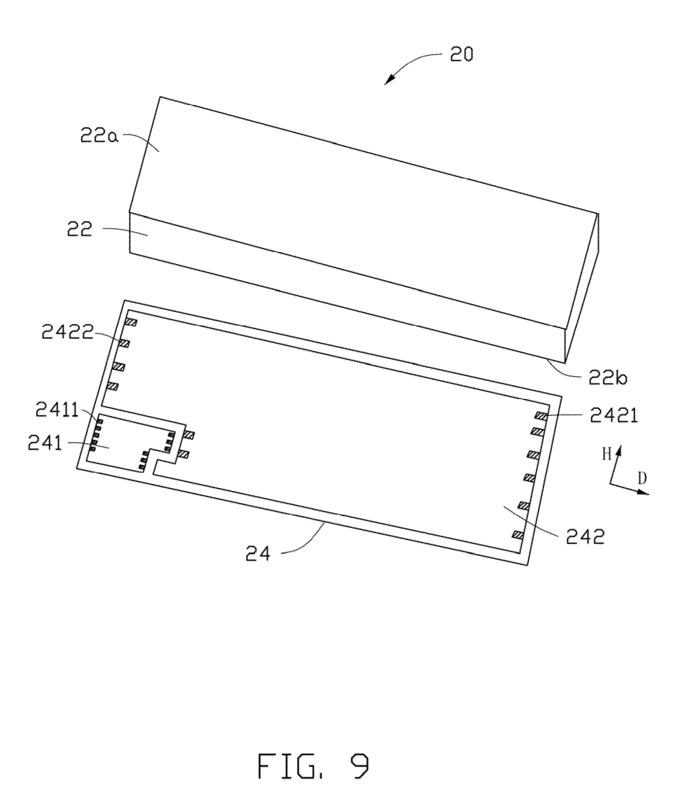

FIG. 9 illustrates that a second embodiment of a touch-control type keyboard 20 includes a cover board 22 and a touch-control module 24. The cover board 22 and the touch-control module 24 are laminated together. The transparent cover board 22 covers the touch-control module 24, and is in contact and fixed on the touch-control module 24. The cover board 22 has a first surface 22a and a second surface 22b. The first surface 22a is the surface nearest to the user and configured to be used as an operating surface of the touch-control type keyboard 20.

The structure of the second embodiment of the touch-control type keyboard 20 is similar to the touch-control type keyboard 10 of first embodiment, except that a first conductive film 241 is located at a position corresponding to both “Ctrl” and “Shift” keys. A second conductive film 242 is located at another area to correspond to other keys except “Ctrl” and “Shift” keys. Each of the first conductive film 241 and the second conductive film 242 is a single-layer conductive film, and is respectively connected to the integrated circuit by separate wires.

A plurality of electrodes can be located on at least one side of each of the first conductive film 241 and the second conductive film 242, and they are arranged along direction H. The plurality of electrodes located on the first conductive film 241 is electrically connected to the first conductive film 241. The plurality of electrodes located on the second conductive film 242 is electrically connected to the second conductive film 242. Each of the plurality of electrodes is connected to a driving circuit and a sensing circuit. In one embodiment, two first electrodes 2411 and two second electrodes 2412 are spaced and located on the opposite sides of the first conductive film 241, and they are arranged along direction H. Two third electrodes 2421 and two fourth electrodes 2422 are spaced and located on the opposite sides of the second conductive film 242, and they are arranged along direction H.

The touch-control type keyboard 20 can further include a keyboard marking layer 28 similar to the keyboard marking layer 18 in the first embodiment. The touch-control type keyboard 20 further includes a backlight module 26 similar to the backlight module 16 in the first embodiment. The backlight module 26 helps the user clearly see the key symbols in the keyboard marking layer 28.

When the touch-control type keyboard 20 is in an operation, the detection principle of the touch point is similar to the detection principle of the second conductive film 142 of the first embodiment. The touch-control module 24 corresponding to the first conductive film 241 can achieve a two point touch. The touch-control module 24 corresponding to the second conductive film 242 can also achieve a two point touch. When the touch objects simultaneously touch a first area of the touch-control module 24 corresponding to the first conductive film 241 and a second area of the touch-control module 24 corresponding to the second conductive film 142, the touch-control type keyboard 20 can achieve a three point or more than three point touch, such as “Ctrl+Shift+K” or other keys to perform command input.

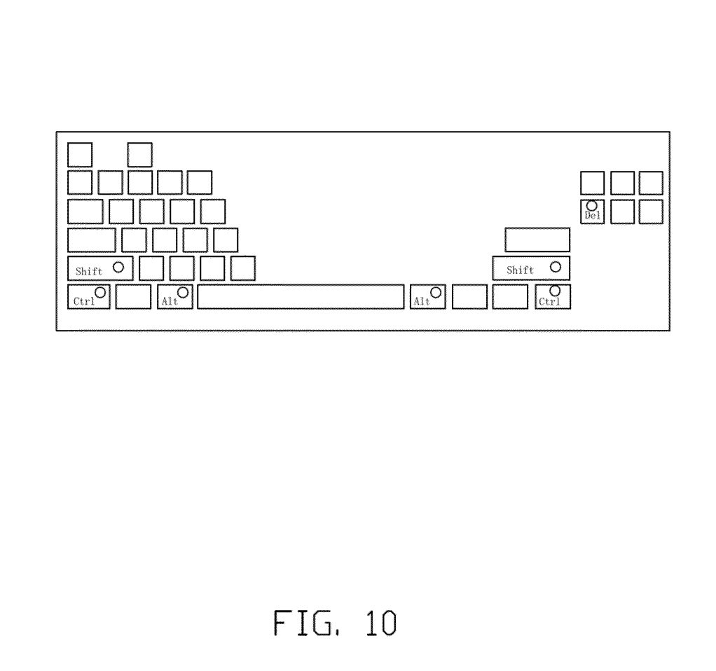

FIG. 10 illustrates that a third embodiment of a touch-control type keyboard 30 includes a cover board 32 and a touch-control module (not shown). The cover board 32 and the touch-control module are laminated together.

The structure of the third embodiment of the touch-control type keyboard 30 is similar to the touch-control type keyboard 10 of first embodiment, except that the number of the function keys is the same as the number of the first conductive films, each of the function keys “Shift”, “Ctrl”, “Alt”, and “Delete” keys correspond to an independent first conductive film, and the other keys except the function keys correspond to an independent second conductive film. The independent first conductive film and the independent second conductive film are respectively connected to the integrated circuit by wires. A strip-shaped or wire-shaped first electrode can be located on at least one side of each independent first conductive film, and it is arranged along direction H. The strip-shaped or wire-shaped first electrode is electrically connected to the independent first conductive film. The strip-shaped or wire-shaped first electrode is also connected to a driving circuit and a sensing circuit. A plurality of second electrodes can be located on at least one side of the independent second conductive film, and they are arranged along direction H. The plurality of second electrodes is electrically connected to the independent second conductive film. Each of the plurality of second electrodes is connected to a driving circuit and a sensing circuit.

The touch-control type keyboard 30 can further include a keyboard marking layer (not shown) similar to the keyboard marking layer 18 in the first embodiment. The touch-control type keyboard 30 further includes a backlight module (not shown) similar to the backlight module 16 in the first embodiment. The backlight module helps the user clearly see the key symbols in the keyboard marking layer.

When the touch-control type keyboard 30 is in operation, the touch point detection principle of the independent second conductive film is similar to the second conductive film 142 of the first embodiment. The touch-control module corresponding to each independent first conductive film can achieve a single point touch; and the touch-control module corresponding to the independent second conductive film can achieve a two point touch. When the touch objects simultaneously touch a first area of the touch-control module corresponding to at least one independent first conductive film and a second area of the touch-control module corresponding to the independent second conductive film, the touch-control type keyboard 30 can achieve a three or more than three point touch, such as “Ctrl+Shift+K” or other keys to perform command input.

The number and the set ways of the conductive films are not limited to the embodiments, as long as the touch-control module comprises at least two independent conductive films, and each independent conductive film is respectively connected to the integrated circuit by separate wires.

The touch-control type keyboard 10, 20 and 30 can be connected to an electronic device via USB port or BLUETOOTH system. The specific coordinates of the touch points can be detected by measuring the capacitance change of the electrical contact points using an electrode probe. A central processor of electronic devices send a corresponding instruction according to the specific coordinates of the touch points to input related information or start the various functions switching of the electronic device; and to control the display contents of the electronic device. As such, the specific location of all the electrical contact points can be determined to achieve a three point or more than a three point touch.

The touch-control type keyboard can have many advantages. The touch-control type keyboard comprises at least two independent conductive films; and each of the at least two independent conductive films is respectively connected to the integrated circuit by separate. Thus, each independent conductive films can achieve two point touch. Therefore, when the touch objects simultaneously touch the at least two independent conductive films, the touch-control type keyboard can achieve at least a three point touch to complete the instruction input. The detection method of the touch points is relatively simple. The touch-control type keyboard uses a single-layer conductive film, which can reduce the thickness and the cost of the touch keyboard.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A touch-control type keyboard comprising:
a cover board comprising a first surface and a second surface opposite to the first surface; and
a touch-control module located on the second surface, wherein the touch-control module comprises at least two conductive films and an integrated circuit; the at least two conductive films are coplanar and spaced from each other; and each of the at least two conductive films is electrically connected to the integrated circuit by separate wires.

2. The touch-control type keyboard of claim 1, wherein each of the at least two conductive films is a single-layer anisotropic impedance conductive film.

3. The touch-control type keyboard of claim 2, wherein the single-layer anisotropic impedance conductive film is carbon nanotube film, comprising a plurality of carbon nanotubes.

4. The touch-control type keyboard of claim 3, wherein a majority of the plurality of carbon nanotubes are substantially aligned along the same direction and joined end to end by van der Waals force.

5. The touch-control type keyboard of claim 1, wherein each of the at least two conductive films is triangular patterned indium tin oxide film.

6. The touch-control type keyboard of claim 1, wherein the cover board defines a plurality of keys on the first surface, and at least one of the plurality of keys is a function key; and the at least one function key is independently located at a position corresponding to one of the at least two conductive films.

7. The touch-control type keyboard of claim 6, wherein a first conductive film is independently located at a position that corresponds to a single function key; and a second conductive film is independently located at a position that corresponds to other keys except the single function key.

8. The touch-control type keyboard of claim 7, wherein one first electrode is located on at least one side of the first conductive film and electrically connected to the first conductive film.

9. The touch-control type keyboard of claim 8, wherein a plurality of second electrodes are located on at least one side of the second conductive film and electrically connected to the second conductive film.

10. The touch-control type keyboard of claim 6, wherein a first conductive film is independently located on a position that corresponds to both two function keys; and a second conductive film is independently located at a position that corresponds to other keys except the two function keys.

11. The touch-control type keyboard of claim 10, wherein at least two first electrodes are located on at least one side of the first conductive film and electrically connected to the first conductive film.

12. The touch-control type keyboard of claim 11, wherein a plurality of second electrodes is located on at least one side of the second conductive film and electrically connected to the second conductive film.

13. The touch-control type keyboard of claim 6, wherein each function key corresponds to an independent first conductive film; and non-function keys corresponds to an independent second conductive film.

14. The touch-control type keyboard of claim 13, wherein a first electrode is located on at least one side of the independent first conductive film and electrically connected to the independent first conductive film; and a plurality of second electrodes is located on at least one side of the independent second conductive film and electrically connected to the independent second conductive film.

15. The touch-control type keyboard of claim 1, wherein the plurality of keys is arranged in a plurality of rows.

16. The touch-control type keyboard of claim 1, further comprising a backlight module located on a side of the touch-control module.

17. The touch-control type keyboard of claim 1, further comprising a keyboard marking layer; and the keyboard marking layer comprises a plurality of key symbols.

18. A touch-control type keyboard comprising:
a cover board comprising a first surface and a second surface opposite to the first surface; and
a touch-control module located on the second surface, wherein the touch-control module comprises a first touch pad, a second touch pad, and an integrated circuit; the first touch pad and the second touch pad are respectively electrically connected to the integrated circuit by separate wires.

19. The touch-control type keyboard of claim 18, wherein the cover board defines a plurality of keys on the first surface, and at least one of the plurality of keys is a function key; and the first touch pad is located at a position that corresponds to the function key;
and the second touch pad is located at a position that corresponds to other of the plurality of keys except the function key.

20. The touch-control type keyboard of claim 18, wherein each of the first touch pad and the second touch pad comprises a single-layer anisotropic impedance conductive film.
